(19) United States
(12) Patent Application Publication
(10) Pub. No.: US 2026/0212759 A1
(43) Pub. Date: Jul. 23, 2026

(54) ROADWAY WORK ZONE WARNING APPLICATION FOR VEHICLES

(71) Applicant: GM GLOBAL TECHNOLOGY OPERATIONS LLC, Detroit, MI (US)

(72) Inventors: Vivek Vijaya Kumar, Shelby Township, MI (US); Hariharan Krishnan, Troy, MI (US); Chuan Li, Troy, MI (US); Shah Hussain, Dearborn, MI (US); Muhammad Rehan, Troy, MI (US)

(73) Assignee: GM GLOBAL TECHNOLOGY OPERATIONS LLC, Detroit, MI (US)

(21) Appl. No.: 19/032,891

(22) Filed: Jan. 21, 2025

(51) Int. Cl. G08G 1/0969; B60W 30/14; B60W 30/18; B60W 50/14; G08G 1/0967

(52) U.S. Cl. CPC G08G 1/0969; B60W 30/146; B60W 30/18163; B60W 50/14; G08G 1/096725; G08G 1/096766; B60W 2050/146; B60W 2520/10; B60W 2555/60; B60W 2556/40; B60W 2556/50

(57) ABSTRACT

Methods and systems are provided that include a transceiver, one or more sensors and location systems of a vehicle, and a processor. The transceiver is configured to at least facilitate obtaining, via one or more remote sources that are remote to the vehicle, work zone data pertaining to a work zone of a roadway in proximity to the vehicle as the vehicle is travelling. The one or more sensors and location systems are configured to at least facilitate obtaining location information as to the vehicle. The one or more processors that are configured to at least facilitate determining display information pertaining to the work zone, based on the work zone data and the location information; and outputting the display information on a display system of the vehicle to a driver, to an automated vehicle system, or both, in accordance with instructions provided by the one or more processors.

### TECHNICAL FIELD

The technical field generally relates to vehicles and, more specifically, to methods and systems for providing warnings to drivers of vehicles pertaining to work zones as the vehicle is being operated.

### BACKGROUND

Vehicles may encounter work zones as the vehicle is being operated, that may include road blockages, detours, workers presents, posted speed, and the like.

Accordingly, it is desirable to provide methods and systems for providing warnings to drivers of work zones as the vehicle is being operated.

### SUMMARY

In accordance with an exemplary embodiment, a method is provided that includes obtaining, via one or more remote sources that are remote to a vehicle, work zone data pertaining to a work zone of a roadway in proximity to the vehicle as the vehicle is travelling; obtaining, one or more sensors and location systems of the vehicle, location information as to the vehicle; determining, via one or more processors, display information pertaining to the work zone, based on the work zone data and the location information; and outputting the display information on a display system of the vehicle to a driver, to an automated vehicle system, or both, in accordance with instructions provided by the one or more processors.

Also in an exemplary embodiment, the location information includes a position and heading of the vehicle as determined via a satellite-based location system of the vehicle in addition to a speed of the vehicle as determined via one or more speed sensors of the vehicle; and the determining of the display information is based on the position, heading, and speed of the vehicle in addition to the work zone data.

Also in an exemplary embodiment, the method further includes determining, via the one or more processors, one or more recommended maneuvers for the vehicle based on the work zone data and the location information; and outputting the one or more recommended maneuvers as part of the display information on the display system of the vehicle, in accordance with instructions provided by the one or more processors.

Also in an exemplary embodiment, the one or more recommended maneuvers include a lane merge based on one or more lane closures based on the work zone data and the location information.

Also in an exemplary embodiment, wherein the one or more recommended maneuvers include a reduction in speed of the vehicle based on one or more changes reductions in a speed limit of the roadway based on the work zone data and the location information.

Also in an exemplary embodiment, further including obtaining, via a remote server that is remote from the vehicle, lane-level map data pertaining to the roadway; and combining, via the one or more processors, the work zone data with the lane-level map data, generated unified work zone data; wherein the display information is determined via the one or more processors based on the unified work zone data.

Also in an exemplary embodiment, the work zone data includes lane-specific work zone data as to any lane closures in one or more specific lanes of the roadway in addition to any speed limit reductions of the roadway as well as whether any workers are present; and the combining includes combining of the lane-specific work zone data with the lane-level map data, including any lane closures, any speed limit reductions, and whether any workers are present, in generating the unified work zone data.

Also in an exemplary embodiment, the determining and outputting of the display information is further based on a ranking of relevance of a plurality of work zones based on respective relative distances of each of the plurality of work zones to the vehicle in addition to respective impacts of relative impacts of each of the plurality of work zones on one or more vehicle maneuvers required for the vehicle, including one or more lane merge maneuvers, one or more speed reductions for the vehicle, or both.

Also in an exemplary embodiment, the method further includes automatically controlling one or more vehicle control actions for the vehicle, via a drive system of the vehicle that is part of the automated vehicle system, in accordance with instructions provided by the one or more processors, based on the work zone data and the location information.

In another exemplary embodiment, a system is provided that includes a transceiver, one or more sensors and location systems of a vehicle, and a processor. The transceiver is configured to at least facilitate obtaining, via one or more remote sources that are remote to the vehicle, work zone data pertaining to a work zone of a roadway in proximity to the vehicle as the vehicle is travelling. The one or more sensors and location systems are configured to at least facilitate obtaining location information as to the vehicle. The one or more processors that are configured to at least facilitate determining display information pertaining to the work zone, based on the work zone data and the location information; and outputting the display information on a display system of the vehicle to a driver, to an automated vehicle system, or both, in accordance with instructions provided by the one or more processors.

Also in an exemplary embodiment, the location information includes a position and heading of the vehicle as determined via a satellite-based location system of the vehicle in addition to a speed of the vehicle as determined via one or more speed sensors of the vehicle; and the one or more processors are configured to at least facilitate determining the display information is based on the position, heading, and speed of the vehicle in addition to the work zone data.

Also in an exemplary embodiment, the one or more processors are configured to at least facilitate determining one or more recommended maneuvers for the vehicle based on the work zone data and the location information; and outputting the one or more recommended maneuvers as part of the display information on the display system of the vehicle, in accordance with instructions provided by the one or more processors.

Also in an exemplary embodiment, the one or more recommended maneuvers include a lane merge based on one or more lane closures based on the work zone data and the location information.

Also in an exemplary embodiment, the one or more recommended maneuvers include a reduction in speed of the vehicle based on one or more changes reductions in a speed limit of the roadway based on the work zone data and the location information.

Also in an exemplary embodiment, the one or more processors are configured to at least facilitate obtaining, via a remote server that is remote from the vehicle, lane-level map data pertaining to the roadway; combining the work zone data with the lane-level map data, generated unified work zone data; and determining the display information based on the unified work zone data.

Also in an exemplary embodiment, the work zone data includes lane-specific work zone data as to any lane closures in one or more specific lanes of the roadway in addition to any speed limit reductions of the roadway as well as whether any workers are present; and the one or more processors are configured to at least facilitate combining the lane-specific work zone data with the lane-level map data, including any lane closures, any speed limit reductions, and whether any workers are present, in generating the unified work zone data.

Also in an exemplary embodiment, the one or more processors are further configured to at least facilitate determining and outputting of the display information further based on a ranking of relevance of a plurality of work zones based on respective relative distances of each of the plurality of work zones to the vehicle in addition to respective impacts of relative impacts of each of the plurality of work zones on one or more vehicle maneuvers required for the vehicle, including one or more lane merge maneuvers, one or more speed reductions for the vehicle, or both.

Also in an exemplary embodiment, the one or more processors are further configured to at least facilitate automatically controlling one or more vehicle control actions for the vehicle, via a drive system of the vehicle that is part of the automated vehicle system, in accordance with instructions provided by the one or more processors, based on the work zone data and the location information.

In another exemplary embodiment, a communications system is provided that includes a vehicle and a remote server. The vehicle has one or more sensors, a location system, and a display system. The remote server is remote from the vehicle and also remote from one or more other data sources that provide lane-specific work zone data as to a work zone along a roadway in which the vehicle is to be travelling, including as to whether any workers are present in the work zone, and further including any closed lanes of the roadway and any speed limit changes of the roadway based on the work zone. The remote server is configured to at least facilitate obtaining the lane-specific work zone data from the one or more other data sources; obtaining lane-level map data pertaining to the roadway on which the work zone is located; and obtaining location information from the vehicle that includes a heading, position, and speed of the vehicle as determined via the one or sensors and the location system of the vehicle; wherein the vehicle, the remote server, or both have one or more processors that are configured to at least facilitate combining the lane-specific work zone data with the lane-level map data, generated unified work zone data with respect to the work zone and the vehicle; determining display information pertaining to the work zone, including one or more recommended maneuvers for the vehicle based on the lane-specific work zone data and the location information, the one or more recommended maneuvers including one or more lane merge maneuvers, one or more speed reductions, or both, based on the work zone; and outputting the display information on the display system of the vehicle to a driver, to an automated vehicle system, or both, including the one or more recommended maneuvers for the vehicle, in accordance with instructions provided by the one or more processors.

Also in an exemplary embodiment, the one or more processors are configured to at least facilitate determining and outputting of the display information further based on a ranking of relevance of a plurality of work zones based on respective relative distances of each of the plurality of work zones to the vehicle in addition to respective impacts of relative impacts of each of the plurality of work zones on one or more vehicle maneuvers required for the vehicle, including the one or more lane merge maneuvers, the one or more speed reductions for the vehicle, or both.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle, a remote server, and a data source, the vehicle having a control system for providing warnings to drivers of work zones as the vehicle is being operated, in accordance with exemplary embodiments;

FIG. 2 is a functional block diagram of the system of FIG. 1, along with a process for providing warnings to drivers of work zones as the vehicle is being operated and that can be implemented in connection with the system of FIG. 1, in accordance with exemplary embodiments;

FIG. 3 is a flowchart of a data flow of the process of FIG. 2, in accordance with exemplary embodiments;

FIGS. 4-11 are flowcharts of various steps and subprocesses of the process of FIG. 2, in accordance with exemplary embodiments;

FIG. 12 is an exemplary implementation of a roadway having a work zone, and in which the process of FIG. 2 can be implemented, in accordance with exemplary embodiments; and

FIGS. 13A and 13B provide exemplary displays that may be provided in connection with certain exemplary implementations of the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

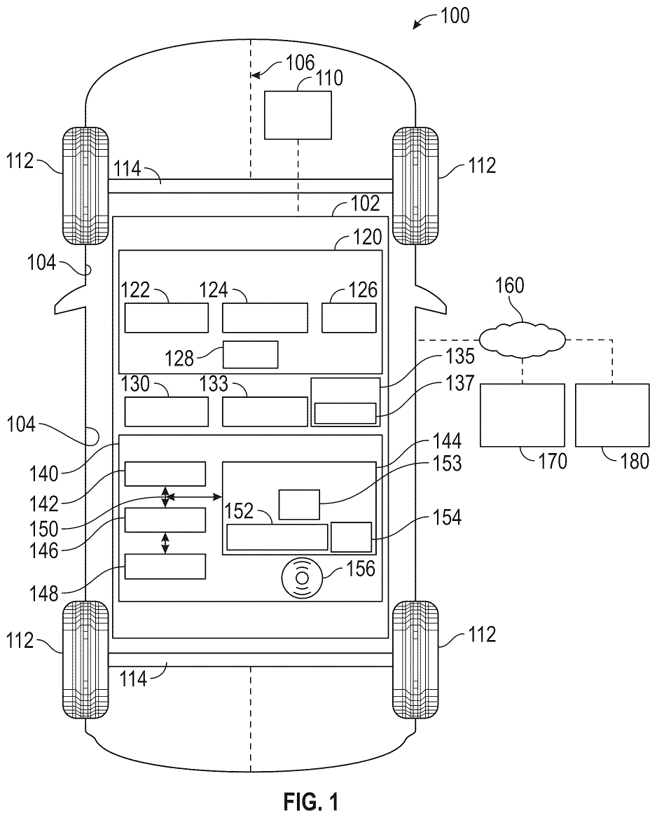

FIG. 1 illustrates a system 10 that includes a vehicle 100, a remote server 170, and one or more data sources 180, in accordance with an exemplary embodiment. As illustrated in FIG. 1, the system 10 further includes one or more wireless communication networks 160 that communicatively couple together the vehicle 100, the remote server(s) 170, and the data source(s) 180.

In certain embodiments, the vehicle 100 is representative of a number of different vehicles (e.g., in a fleet) that are likewise coupled to the remote server 170 and/or data source 180 via the wireless communication networks 160, and that have similar features as those depicted in FIG. 1 and described below in connection with the vehicle 100. Also in various embodiments, the remote server 170 is representative of one or more remote computer servers. In addition, in various embodiments, the data source 180 represents one or more data sources, such as governmental highway, roadway, and/or traffic information providers, and/or other types of data sources that may provide information as to work zones, workers present in work zones, construction and/or traffic along roadways, and the like.

In various embodiments, and as described below, the vehicle 100 includes a control system 102 for providing warnings to drivers of work zones as the vehicle is being operated.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

In various embodiments, the vehicle 100 is operated in whole or in part by a human driver. In certain other embodiments, the vehicle 100 may comprise an autonomous or semi-autonomous vehicle, for example in which vehicle control (including propulsion, steering, braking, and the like) is automatically planned and/or executed by the control system 102, in whole or in part.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain embodiments, the drive system 110 provides propulsion in accordance with a driver intent as manifested via the driver's engagement of an accelerator pedal. Also in certain embodiments, the drive system 110 may also provide automatic propulsion control in appropriate circumstances in accordance with instructions provided by the control system 102.

In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In the embodiment depicted in FIG. 1, the control system 102 is coupled to the drive system 110 as well as to the remote server(s) 170 (and/or in certain embodiments also to the data source(s) 180). As noted above, in certain embodiments, the vehicle 100 includes one or more functions controlled automatically via the control system 102, including for providing warnings to drivers of work zones as the vehicle is being operated.

As depicted in FIG. 1, in various embodiments, the control system 102 includes a sensor array 120, a location system 130, a transceiver 133, a display system 135, and a controller 140.

In various embodiments, the sensor array 120 includes various sensors that are used for facilitating of egress of passengers from vehicles. In the depicted embodiment, the sensor array 120 includes one or more speed sensors 122, detection sensors 124, and input sensors 126. In various embodiments, the sensor array 120 may also include one or more other sensors 128.

In various embodiments, the speed sensors 122 obtain sensor data pertaining a speed or velocity of the vehicle 100. In certain embodiments the speed sensors 122 comprise one or more wheel speed sensors coupled to one or more of the wheels 112; however, this may vary in other embodiments.

In certain embodiments, the sensor array 120 also includes one or more detection sensors 124, such as one or more cameras, radar sensors, Lidar sensors, sonar sensors, or the like, that are configured to obtain detection sensor data as to a roadway and environment surrounding the vehicle 100.

In various embodiments, the one or more input sensors 126 obtain inputs from a user (such as a driver of the vehicle 100). In certain embodiments, the inputs may include, by way of example, a desired transmission gear for the vehicle 100, along with braking, acceleration, steering, location of travel, and/or other inputs.

Also in various embodiments, the sensor array 120 may further include one or more other sensors 128. In certain embodiments, the other sensors 128 may include one or more accelerometers, inertial measurement unit (IMU) sensors, transmission and/or gear sensors, and so on, among other possible vehicle sensors.

In certain embodiments, the vehicle 100 also includes a transceiver 133. In various embodiments, the transceiver 133 communicates with the remote servers 170 (and in certain embodiments the data sources 180) via the one or more wireless communication networks 160, along with communication with the electronic device 105 via the wireless connection 103.

In various embodiments, the display system 135 provides information or instructions for one or more passengers of the vehicle 100, including as to work zones as the vehicle 100 and recommended courses of action for the driver to take while operating the vehicle 100 (e.g., changing lanes, reducing speed, and so on). In various embodiments, the display system 135 includes one or more visual components 137, such as a display screen. In certain embodiments, the display system 135 may also include one or more other components, such as an audio component (e.g., a speaker), a haptic component (e.g., by shaking a passenger seat), or the like.

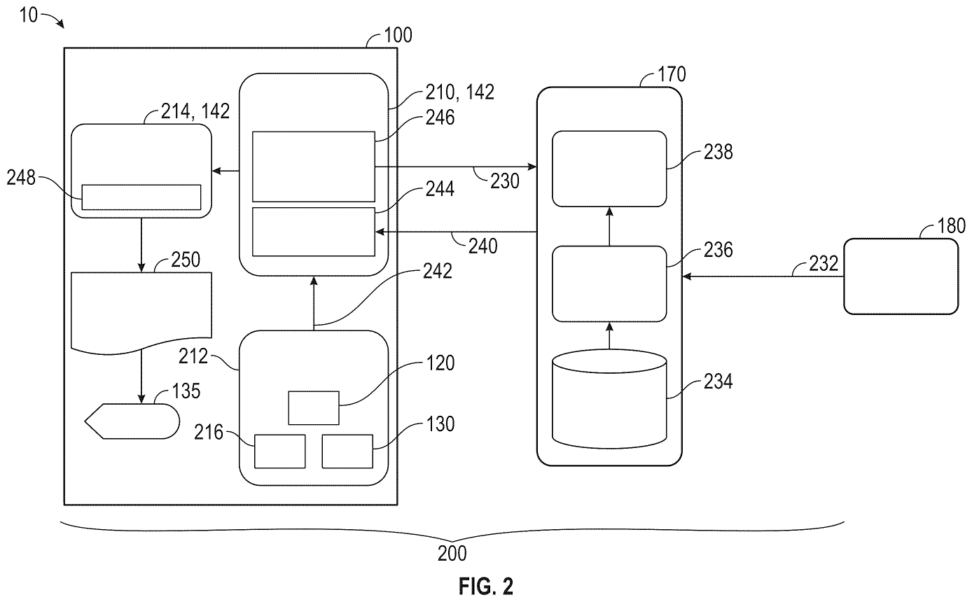

In various embodiments, the controller 140 is coupled to the sensor array 120, the location system 130, the transceiver 133, and the display system 135, as well as to the remote servers 170 (and in certain embodiments the data sources 180). In certain embodiments, the control system 102 is also coupled to the drive system 110 and/or to one or more other components of the vehicle 100. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 provides warnings as to work zones as the vehicle 100 is being operated, based on the sensor data obtained from the sensor array 120 along with information obtained from the remote servers 170 and data sources 180 (directly or indirectly) via the transceiver 133. In various embodiments, the controller 140 provides these and other functions in accordance with the steps of the processes and implementations depicted in FIGS. 2-13B and as described further below in connection therewith.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 and/or control system 102 and/or one or more components thereof may be disposed outside the body 104, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the processes and implementations depicted in FIGS. 2-13B and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with map data 153 and one or more stored values 154 (e.g., including, in various embodiments, threshold values).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120, the location system 130, and/or the remote servers 170. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of the processes and implementations of FIGS. 2-13B and as described further below in connection therewith. In another exemplary embodiment, the program product may be directly stored in and/or otherwise accessed by the memory 144 and/or a disk (e.g., disk 157), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With continued reference to FIG. 1, as depicted in FIG. 1 and as described above, in various embodiments the remote server 170 is coupled to the vehicle 100 and to the data sources 180 via the one or more wireless communication networks 160. Similar to the discussion above, in various embodiments, the remote server 170 depicted in FIG. 1 may be representative of one or more different remote servers 170. In addition, in various embodiments, the remote server 170 may include, among other components, a processor, a memory, a transceiver, and other devices and systems with similar functionality as the corresponding devices and systems of the vehicle 100.

Also as depicted in FIG. 1, in various embodiments the data sources 180 include one or more providers of information pertaining to work zones on roadways, such as governmental highway, roadway, and/or traffic information providers, and/or other types of data sources that may provide information as to work zones, workers present in work zones, construction and/or traffic along roadways, and the like.

In various embodiments, the data sources 180 provide information pertaining to work zones (including as to lane-specific information as to work zones, and further including information as to whether workers are present) to the remote servers 170, which in turn provide such information, along with additional information (including as to lane-based mapping data) to the vehicle 100 vias the communications networks 160 for further processing and use by the vehicle 100.

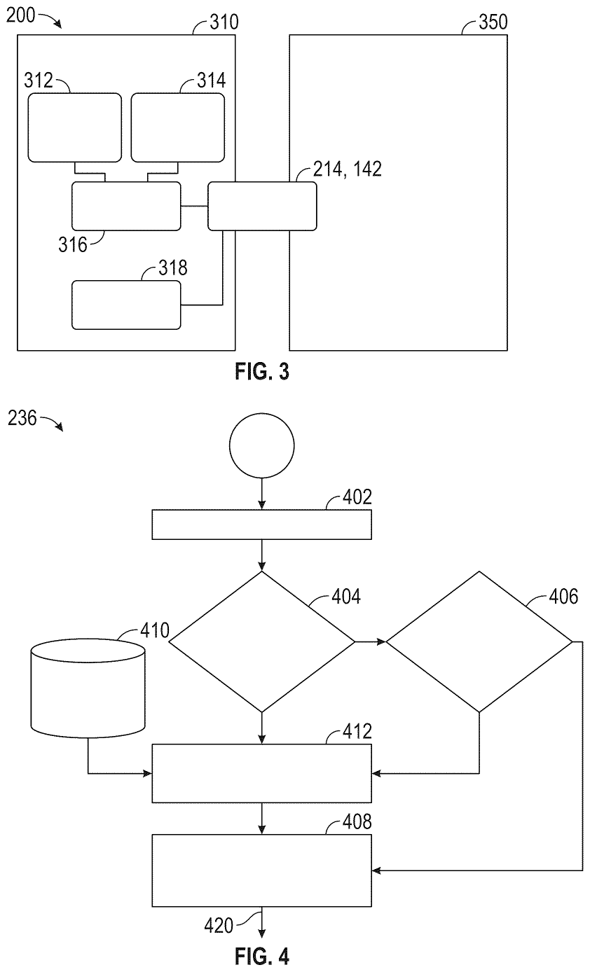

FIG. 2 is a functional block diagram of the system 10 of FIG. 1, along with a process 200 for providing warnings to drivers of work zones as the vehicle 100 is being operated and that can be implemented in connection with the system 10 of FIG. 1, in accordance with exemplary embodiments. In various embodiments, the process 200 is described further below in connection with the diagram of FIG. 2 as well as FIGS. 3-13B, which depict data flow, subprocesses, and implementations of the process 200.

As depicted in FIG. 2, in various embodiments, the vehicle 100 is coupled to the remote server 170, which is in turn coupled to data source 180. In various embodiments, the vehicle 100, remote server 170, and data source 180 each perform functions of or relating to the process 200, as described in greater detail further below.

Also as depicted in FIG. 2, the vehicle 100 processes are performed and implemented using the processor 142 of FIG. 1, along with a communication manager 210, onboard unit (OBU) 212, and work zone application 214. In various embodiments, the communication manager 210 and the work zone application both include, utilize, and/or are coupled to one or more processors 142 of FIG. 1. In addition, as depicted in FIG. 2, the OBU 212 includes the sensor array 120 and location system (e.g., GPS) 130 of FIG. 1, in addition to an onboard communication network 216, such as a controller area network (CAN) bus 216.

In various embodiments, as part of the process 200, a request is made from the vehicle 100 to the remote server 170 (step 230). In various embodiments, during step 230, the vehicle 100 requests information regarding possible work zones as the vehicle 100 is operating. In various embodiments, the request is made via the communication manager 210 of the vehicle 100 (e.g.,. via the processor 142 and transceiver 133 of FIG. 1) to the remote server 170 of FIG. 1 via the communications network 160 of FIG. 1. In certain embodiments, the request of step 230 comprises a hypertext transfer protocol (HTTP) request.

In various embodiments, work zone data is provided (step 232). As depicted in FIG. 2, the data source 180 (e.g., in certain embodiments, a governmental authority pertaining to roadways, construction, and the like) provides data as to work zones, including as to geographic locations in which the vehicle 100 may travel that may include construction, road improvements, lane closures, detours, speed limit changes, workers present, and the like. In various embodiments, the work zone data is provided by the data source 180 (or, in certain embodiments, multiple data sources 180) to the remote server 170 via the communications network 160 of FIG. 1. In various embodiments, the work zone data includes road-specific data as to work zones. In certain embodiments, the work zone data may also include lane-specific work zone data; however, in certain other embodiments, the lane-specific data may instead be obtained from a mapping database (e.g., as described in greater detail further below).

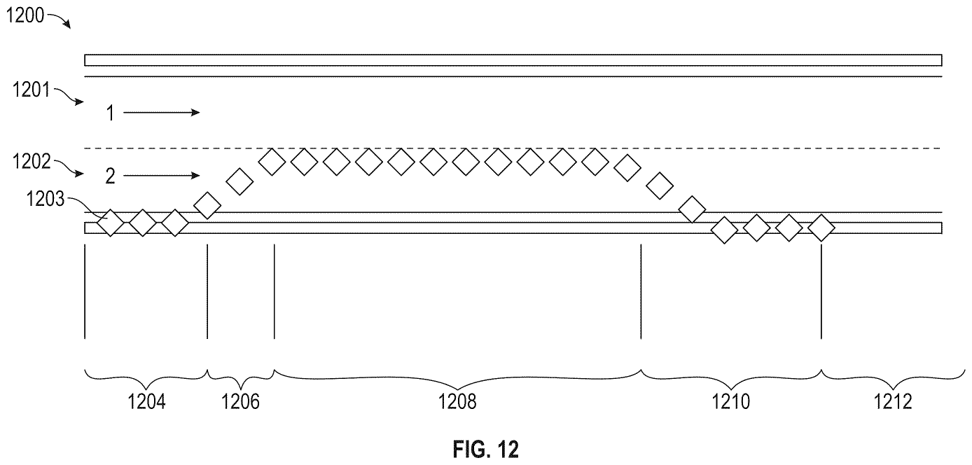

With reference to FIG. 12, in an exemplary embodiment an illustration 1200 is provided of an exemplary work zone that may be represented by the work zone data and utilized in connection with the process 200 of FIG. 2 in accordance with exemplary embodiments. As depicted in FIG. 12, the work zone occurs on a roadway with one or more lanes 1201 and 1202. Also as depicted in FIG. 12, the vehicle 100 travels along path 1203 around the work zone in certain embodiments (which may include merging as illustrated in FIG. 12). Also as depicted in FIG. 12, in an exemplary embodiment, the work zone includes an advance warning area 1204 (e.g., in which a warning or other notification is first provided to the driver in accordance with the process 200); a transition area 1206 in which the vehicle 100 approaches the work zone (and in which the vehicle 100 may begin taking certain maneuvers such as merging and/or slowing down in certain embodiments); an area of work zone activity area 1208 (e.g., in which workers are present, lanes are closed, and so on, with the work zone); a termination area 1210 (e.g., in which the vehicle 100 may begin to reverse the maneuver (e.g., by returning to the original lane or position of the vehicle 100, returning the vehicle 100 to its original speed, and so on); and an ending are 1210 for the work zone (i.e., where the work zone ends).

With reference back to FIG. 2, in various embodiments, the remote server 170 utilizes the work zone data of step 232 in performing various processing and related steps in order to provide the work zone data, along with related information, to the vehicle 100 in response to the vehicle 100's request of step 230. In various embodiments, these steps performed by the remote server 170 include utilizing a mapping database (step 234), providing required details such as lane-level mapping, work zone start and end location, lane closures, and the like (step 236), and providing location-based data filtering (step 238), as depicted in FIG. 2 and as described below.

In various embodiments, one or more mapping databases are utilized in step 234 for relating the work zone data of step 232 to specific geographic regions in which the vehicle 100 may be travelling. In various embodiments, the mapping databases may include the map database 153 stored in the vehicle 100, and/or similar mapping databases that are either stored in a memory of the remote server 170 and/or obtained from the remote server 170 via one or more other sources (e.g., in certain embodiments, one or more online map providers). Also in various embodiments, the mapping databases are related to a geographic location in proximity to the vehicle 100, for example utilizing location information provided by the location system (e.g., GPS) 130 of the vehicle 100. In certain embodiments, this includes utilizing a geo-fence of geographic locations that are in proximity to the vehicle 100, including for narrowing the field of the work zone data as presented to and utilized for the vehicle 100 for the current vehicle drive.

Also in various embodiments, the mapping databases are also utilized for the lane-level mapping service of step 236. Specifically, in various embodiments, the remote server 170 further utilizes the mapping database of step 234 along with the work zone data of step 232 to provide lane-specific work zone conditions and information for the vehicle 100, including with reference to the current lane of the vehicle 100 as well as potential lane changes that may be desired or required for the vehicle 100 due to the work zones that may be in proximity to the vehicle 100.

In addition, in various embodiments, the work zone data of step 232, the mapping databases of step 234, and the lane-level mapping service of step 236 are further utilized by the remote server 170 in providing the location-based data filtering of step 238. Specifically, in various embodiments, the remote server 170 further utilizes the work zone data, the mapping databases, and the lane-level mapping service to further refine the work zone data relating to the geofence in proximity to the geographic location of the vehicle 100 and/or of the vehicle 100's projected path of travel, along with recommendations for the driver of the vehicle 100 to take with respect to operation of the vehicle 100 through one or more work zones (e.g., reducing speed, changing lanes, and so on).

In various embodiments, the remote server 170 provides a response to the vehicle 100 (step 240). In various embodiments, the response of step 240 is in response to the request by the vehicle 100 of step 230. Also in various embodiments, the response of step 240 includes the information of steps 232-238 (including the refinements of steps 234-238) pertaining to the work zones in proximity to the geographic location of the vehicle 100 and/or of the vehicle 100's projected path of travel, along with recommendations for the driver of the vehicle 100 to take with respect to operation of the vehicle 100 through one or more work zones (e.g., reducing speed, changing lanes, and so on). Also in various embodiments, the response of step 240 is provided via the remote server 170 (e.g., via a transceiver of the remote server 170 and in accordance with instructions provided by a processor of the remote server 170) to the vehicle 100 via the communications network 160 of FIG. 1, and is received by the vehicle 100 via the communication manager 210 (e.g., via the transceiver 133 and ultimately the processor 142 of the vehicle 100). In certain embodiments, the response of step 240 comprises a hypertext transfer protocol (HTTP) response.

Also as depicted in FIG. 2, vehicle dynamics information is also obtained via the vehicle 100 (step 242). In various embodiments, during step 242, sensor data and vehicle location data are obtained with respect to the vehicle 100, via the OBU 212 of FIG. 2 (e.g., via the sensor array 120 and the location system 130, respectively, of FIG. 1). In various embodiments, the sensor data includes information as to a velocity of the vehicle 100, among other vehicle parameters (e.g., gear status, acceleration, driver inputs, and so on). Aso in various embodiments, the vehicle location data includes information as to the geographic location of the vehicle 100, including a position (e.g., latitude and longitude) and heading (e.g., heading angle) of the vehicle 100. In various embodiments, the sensor data and the vehicle location data are provided from the sensor array 120 and the location system 130, respectively, via the CAN bus 216 to the processor 142 of the communication manager 210.

Also in various embodiments, the data and information provided by the remote server 170 and the OBU 212 are utilized by the communication manager 210 (e.g., by the processor 142) in performing work zone data parsing (step 244) and vehicle dynamics data parsing (step 246). In various embodiments, during step 244, the work zone data and related information provided by the remote server 170 as part of the request of step 230 is processed further by the communication manager 210 (e.g., via the processor 142) to further refine the work zone data and related information with respect to the current vehicle drive. Also in various embodiments, the refinement of the work zone data is further performed with respect to the vehicle dynamics information of step 242, which itself is further refined in step 246 based on the work zone data (e.g., based on applicability with respect to nearby work zones, based on the position, heading, and speed of the vehicle 100, and so on).

In various embodiments, the results of the processing of the communication manager 210 are provided to the work zone application 214 for further processing of step 248. Specifically, in various embodiments, the results of the work zone data parsing of step 244 and the vehicle dynamics data parsing of step 246 are utilized by the work zone application 214 in step 248 to prepare the final information and instructions for the driver of the vehicle 100. In various embodiments, the final information and instructions include a visual display indicating the presence of a work zone in proximity to the vehicle 100, including information relating to the work zone (including which lanes if any are blocked, any changes in speed limit, a distance from the work zone, a duration of the work zone, recommended lane changes for the vehicle 100, presence of workers, and so on). In certain embodiments, the final information and instructions are determined in step 248 via one or more processors 142 of FIG. 1.

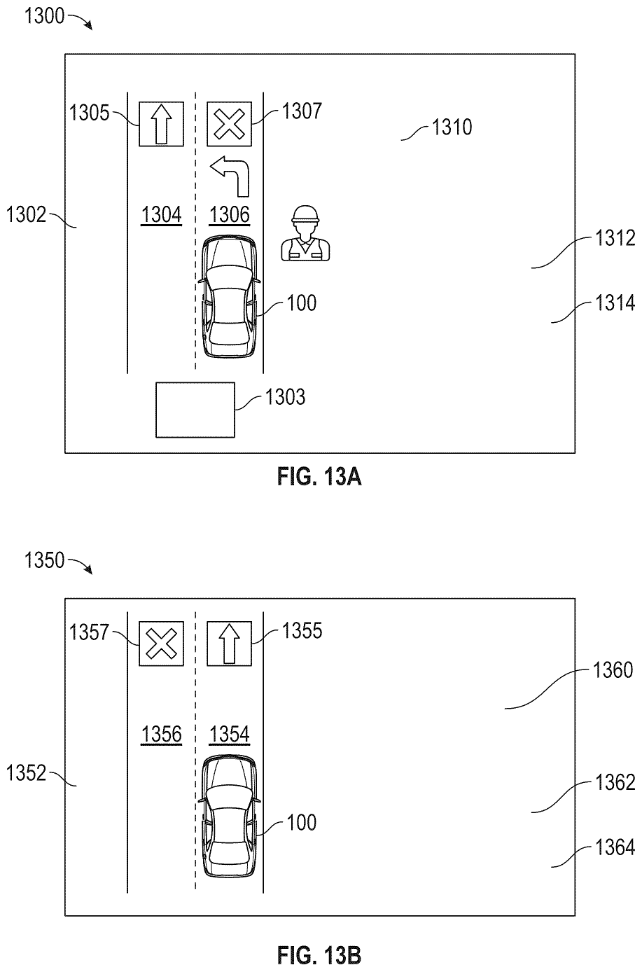

In various embodiments, output is provided for the user (step 250). Specifically, in various embodiments, the processor 142 of FIG. 1 (e.g., as part of and/or in connection with the work zone application 214 of FIG. 2) provides instructions for the final information and instructions pertaining to the work zone (including details and recommendations) for the driver of the vehicle 100. In various embodiments, the final information and instructions are provided as the output for the driver of the vehicle 100 via the display system 135 (e.g., on a display screen thereof) in accordance with instructions provided by the processor 142. In certain embodiments, one or more audio (e.g., via a speaker) and/or haptic (e.g., via vibration of a chair or the like) notifications may also be provided. In certain embodiments, the display provided as part of step 250 may include features of the exemplary displays of FIGS. 13A and 13B that are described further below in connection therewith.

Various implementations of the process 200 of FIG. 2 will now be discussed with respect to FIGS. 2-13B.

With reference first to FIGS. 13A and 13B, exemplary displays 1300 and 1350, respectively, are provided in connection with certain exemplary implementations of the process 200 of FIG. 2 (and specifically with respect to the outputting of the display in step 250 of FIG. 2), in accordance with exemplary embodiments. In various embodiments, the exemplary displays 1300 and 1350 are provided via a display screen of the display system 135 of FIG. 1, for example as part of a head up display (HUD) in certain embodiments, and/or as part of navigation system display and/or one or more other types of dash displays for the driver in various embodiments. Also in various embodiments, as shown in FIGS. 13A and 13B, the displays 1300 and 1350 provide lane-level details of the work zone, including any recommendations as appropriate for vehicle control actions (such as merging, changing lanes, and/or reducing speed of the vehicle 100).

In accordance with an exemplary embodiment, the display 1300 of FIG. 13A is utilized in a situation in which the vehicle 100 is approaching a work zone, in accordance with an example in which a lane merge maneuver is recommended. As shown in FIG. 13A, the display 1300 depicts the vehicle 100 travelling in proximity to a work zone 1303. The display 1300 also depicts the speed limit 1302 associated with the work zone (e.g., equal to fifty five miles per hour in the example of FIG. 13A). Also as shown in FIG. 13A, the vehicle 100 is depicted travelling in its current lane 1306, next to an adjacent lane 1304. Also in the example of FIG. 13A, a first indication 1305 (e.g., with a green arrow) shows that the adjacent lane 1304 is open, whereas a second indication 1307 (e.g., with a red “x”) shows that the current lane 1306 is closed. Accordingly, a recommendation 1310 is provided for the vehicle 100 to merge left. Also as shown in FIG. 13A, in the depicted embodiment, a first distance 1312 to the start of the work zone 1303 is provided, along with a second distance 1314 to the end of the work zone 1303. In addition, also as depicted in FIG. 13A, in various embodiments when workers are present an indication is provided to that effect (e.g., with the depiction of a worker as shown in FIG. 13A).

In accordance with another exemplary embodiment, the display 1350 of FIG. 13B is utilized in a situation in which the vehicle 100 is approaching a work zone, in accordance with a different example in which a lane merge maneuver is not recommended. As shown in FIG. 13B, the display 1350 depicts the vehicle 100 travelling in proximity to a work zone. The display 1350 also depicts the speed limit 1352 associated with the work zone (e.g., equal to twenty five miles per hour in the example of FIG. 13B). Also as shown in FIG. 13B, the vehicle 100 is depicted travelling in its current lane 1354, next to an adjacent lane 1356. Also in the example of FIG. 13B, a first indication 1355 (e.g., with a green arrow) shows that the current lane 1354 is open, whereas a second indication 1357 (e.g., with a red “x”) shows that the adjacent lane 1356 s closed. Accordingly, a recommendation 1360 is provided for the vehicle 100, stating that no merging maneuver is required. Also as shown in FIG. 13B, in the depicted embodiment, a first distance 1362 to the start of the work zone is provided, along with a second distance 1364 to the end of the work zone.

Next, with reference to FIG. 3, an exemplary data flow is provided with respect to the process 200 of FIG. 2, in accordance with an exemplary embodiment. As depicted in FIG. 3, in an exemplary embodiment, the process 200 includes various inputs 310 and outputs 350.

Specifically, as depicted in FIG. 3, in an exemplary embodiment the inputs 310 include a work zone feed 312, a workers location feed 314, cloud server information 316, and vehicle data 318.

In various embodiments, the work zone feed 312 includes information from the data sources 180 of FIGS. 1 and 2 (e.g., as part of the work zone data of step 232 of FIG. 1). Specifically, in certain embodiments, the work zone feed 312 includes a road-level map (including of the work zone isa), lane closure information, and speed limits associated with the work zone.

Also in various embodiments, the workers location feed 314 also includes information from the data sources 180 of FIGS. 1 and 2 (e.g., also as part of the work zone data of step 232 of FIG. 1). Specifically, in certain embodiments, the workers location feed 314 includes information as to location of workers (e.g., humans) as part of or relating to the work zone, along with associated speed limits pertaining to the location of the workers.

In certain embodiments, the remote server 170 obtains the work zone feed 312 and the workers location feed 314 via a cloud-based subscription from one or more of the data sources 180 (e.g., via state department of transportation and/or other entity). In certain other embodiments, workers location feed could also be part of the work zone feed referenced above.

Also in various embodiments, the cloud server information 316 includes information provided by the remote server 170 of FIGS. 1 and 2. In various embodiments, the cloud server information 316 includes the information from the work zone feed 312 and the workers location feed 314, along with additional information, as processed by the remote server 170. Specifically, in various embodiments, the cloud server information 316 includes the information from the response step 240 of FIG. 2, including the various information from the work zone data of step 232, the mapping database of step 234, the lane-level mapping service of step 236, and the location based data filtering of step 238 of FIG. 2.

Also in certain embodiments, the remote server 170 provides processed information from the work zone feed 312 and the workers location feed 314, along with lane-level map data, in the form of a single work zone data packet that is provided to the vehicle 100 for each work zone that the vehicle 100 may encounter during its current vehicle drive (e.g., via cellular communications in certain embodiments).

In addition, with continued reference to FIG. 3, the vehicle data 318 includes information as to the vehicle speed, heading, and location, including as determined via the OBU 212 of FIG. 2 (including via the sensor array 120 and the location system 130) as part of the vehicle dynamics of step 242 of FIG. 2.

With continued reference to FIG. 3, in various embodiments the work zone application 214 (including via the processor 142 in various embodiments) processes the various information from the work zone feed 312, workers location feed 314, cloud server information 316, and vehicle data 318 in providing the outputs 350 for the user (e.g., driver) of the vehicle 100. In various embodiments, the outputs 350 include, among other possible information, a relative distance from the vehicle 100 to both a beginning of the work zone (i.e., corresponding to the transition area 1206 or the beginning of the work zone activity area 1208 of FIG. 12 in an exemplary embodiment) and an end of the work zone (i.e., corresponding to the termination area 1210 or work zone ending area 1212 of FIG. 12 in an exemplary embodiment), speed limit reductions of the work zone, location of workers along the work zone, lane closures, and suggested vehicle maneuvers pertaining to the work zone.

With reference now to FIG. 4, an exemplary implementation is provided for step 236 of FIG. 2, namely providing lane-level mapping service, in accordance with an exemplary embodiment.

As depicted in FIG. 4, in an exemplary embodiment, work zone data is obtained (step 402). In various embodiments, the work zone data is obtained by the remote server 170 from the data source 180. In certain embodiments, this is performed as part of step 232 of FIG. 2, for use in step 236.

Also in various embodiments, a determination is made as to whether the work zone data includes lane-level maps (step 404). In certain embodiments, this is performed via a processor of the remote server 170, as to whether the work zone data of step 402 includes lane-level maps of the roadway(s) that include the work zone.

In various embodiments, if it is determined in step 404 that the work zone data already includes lane-level maps, then a determination is made as to whether the maps meet one or more predefined criteria (step 406). In certain embodiments, this is performed via a processor of the remote server 170, with respect to whether the maps associated with the work zone data meet specified criteria, including as to specificity, precision, and/or accuracy.

In various embodiments, if it is determined in step 406 maps meet the defined criteria, then in various embodiments, unified work zone data is created (step 408). Specifically, in various embodiments, during step 408, a processor (e.g., of the remote server 170) creates unified work zone data that includes the lane-level mapping data. In various embodiments, the unified work zone data (including the lane-level mapping data is then provided for the user (step 420).

With reference back to step 406, if it is instead determined in step 406 that the maps do not meet the defined criteria, then the process proceeds to step 412. In various embodiments, during step 412, a mapping database 410 is obtained, for example by the remote server 170 from the vehicle 100 (e.g., via the map database 153 of the memory 144) and/or via one or more other sources (e.g., one or more other data sources 180 and/or one or more other remote sources). In various embodiments, the process 200 then proceeds to the above-described steps 408 and 420, in which the unified work zone data is generated using the lane-level mapping data (in this iteration, using the mapping database 410) (step 408) and provided to the user (step 420).

With reference back to step 404, if it is instead determined in step 404 that the work zone data does not include lane-level maps, then the process 200 similarly proceeds to steps 412, 408, and 420, as described above, utilizing the mapping database 410 for the lane-level mapping data (step 412) and for creating the unified work zone data (step 408) and providing for the user (step 420).

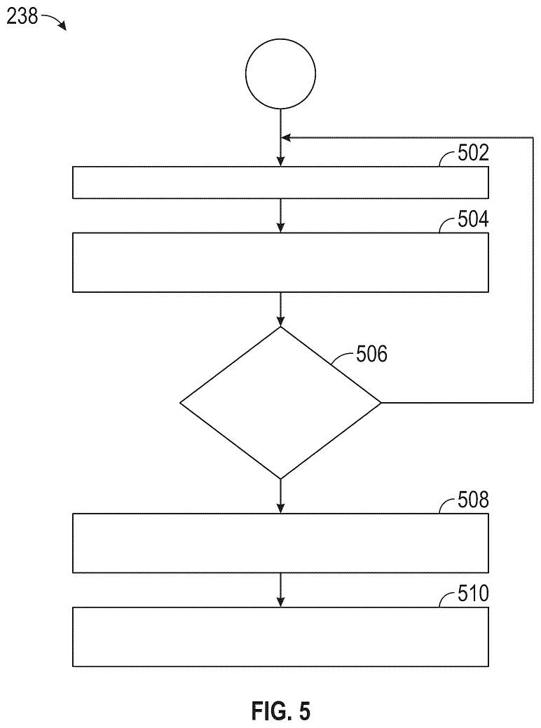

With reference now to FIG. 5, an exemplary implementation is provided for step 238 of FIG. 2, namely providing location-based data filtering, in accordance with an exemplary embodiment.

As depicted in FIG. 5, in an exemplary embodiment, a vehicle request is received that includes information as to the current vehicle location (step 502). In certain embodiments, this corresponds to the request of step 230 of FIG. 2, and includes a request for information from the vehicle 100 to the remote server 170, along with information as to the geographic location and heading of the vehicle 100.

In various embodiments, queries are performed (step 504). Specifically, in various embodiments, the remote server 170 (e.g., via a processor thereof) performs queries of all work zone feeds within a predetermined geofenced area based on the current location of the vehicle 100. In certain embodiments, the geofenced area is based on all geographic locations within a predetermined distance from the vehicle 100 in all directions. In certain embodiments, the geofenced area comprises ten miles in each direction from the vehicle 100; however, this may vary in other embodiments.

In various embodiments, determinations are made is to whether the data is valid and current (step 506). Specifically, in various embodiments, the remote server 170 (e.g., via a processor thereof) performs a determination for each work zone feed as to whether the data is valid and obtained within a predetermined amount of time (i.e., such that the data is valid and current).

In various embodiments, if it is determined in step 506 that the data is not valid, not current, or both with respect to any particular work zone feeds, then in various embodiments, the process returns to step 502, and steps 502-506 thereafter repeat in new iterations until a determination is made in a subsequent iteration of step 506 that the data is valid and current.

In various embodiments, once it is determined in step 506 that the data is valid and current, then the work zones are ranked (step 508). Specifically, in various embodiments, the work zones are ranked in terms of relevance and priority to the vehicle 100. In certain embodiments, the remote server 170 (e.g., via a processor thereof) ranks the work zones represented in the work zone feeds based both on (a) a geographic proximity to the vehicle 100; and (b) a measure of significance of the impact of the work zone (e.g., in terms of required lane changes, reductions in speed, traffic congestion, and the like).

Also in various embodiments, information as to the highest ranked work zones are provided to the vehicle 100. In various embodiments, lane-specific information as to the highest ranked work zones (i.e., the work zones that the closest in distance to the vehicle 100 and would have the most impact for the vehicle 100) are transmitted from the remote server 170 to the vehicle via the communications network 160.

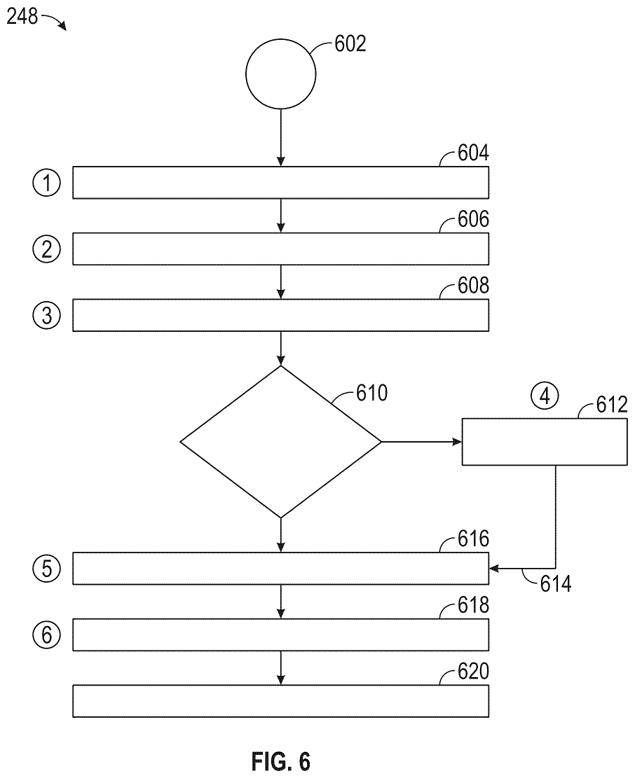

With reference now to FIG. 6, an exemplary implementation is provided for step 248 of FIG. 2, namely performing work zone processing, in accordance with an exemplary embodiment.

As depicted in FIG. 6, in an exemplary embodiment, the sub-process of step 248 begins at 602, after which a relevant work zone is selected (step 604). In certain embodiments, a processor (such as the processor 142) selects a work zone that is the most relevant work zone (e.g., in terms of distance and/or impact) within the path of trajectory of the vehicle 100.

In various embodiments, the work location feeds are also obtained with respect to the most relevant work zone (step 606), along with information as to speed limit reductions pertaining to the most relevant work zone (step 608). In various embodiments, these are obtained via the processor, for example based on information obtained via a transceiver coupled thereto (e.g., via the processor 142 and transceiver 133 in an exemplary embodiment).

Also in various embodiments, a determination is made as to whether lane level map data is available (step 610). In various embodiments, if it is determined in step 610 that lane level map data is available, then in various embodiments a lane of travel of the vehicle 100 is determined (step 612), resulting in an outputted travel lane 614, which is used to determine a suggested maneuver in step 616 (e.g., a suggested lane change for the vehicle 100 and suggested reductions in speed for the vehicle 100). Conversely, in various embodiments, if the lane-level map data is not available, then in certain embodiments the suggested maneuver is determine in step 616 without the lane level map data (e.g., in this case, the suggested maneuver may pertain only to reductions in vehicle speed in certain embodiments). In various embodiments, these determinations and steps are performed via a processor, such as the processor 142.

In various embodiments, system output is created (step 618). In various embodiments, the system output is generated via one or more processors (such as the processor 142 of FIG. 1) to include the suggested maneuver of step 616 along with additional information pertaining to the work zone (e.g., including a distance to the work zone, a duration of the work zone, lane closures relating to the work zone, speed limit reductions pertaining to the work zone, and so on).

Also in various embodiments, the system output is provided for the user (step 620). In various embodiments, the system output of step 618 is provided for a driver of the vehicle 100 via the display system 135 of FIG. 1 (including on a display screen, speaker, haptic component, and/or other components thereof) in accordance with instructions provided by the processor 142. In certain embodiments, the system output may include one or more audio, visual, and/or haptic notifications and/or combinations thereof.

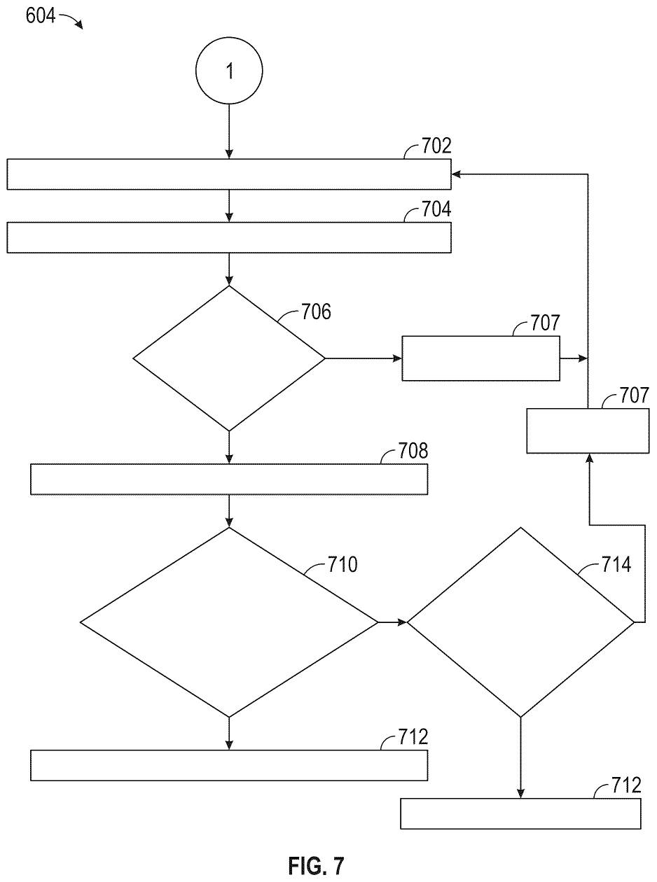

With reference now to FIG. 7, an exemplary implementation is provided for step 604 of FIG. 6 (as part of step 248 of FIG. 2), namely selecting the relevant work zone, in accordance with an exemplary embodiment.

As depicted in FIG. 7, in an exemplary embodiment, the processor finds and iterates all the work zones from the work zone feed using a unique work zone identification (step 702).

Also in various embodiments, the processor computes a work zone difference heading (diff_heading) (step 704). In various embodiments, the work zone difference heading is calculated as the difference between the heading of the work zone minus the heading of the vehicle.

In various embodiments, a determination is made as to whether an absolute value of the work zone difference heading is less than a predetermined threshold (step 706). In various embodiments, this is performed by the processor (e.g. the processor 142). Also in certain embodiments, the predetermined threshold is equal to twenty five degrees; however, this may vary in other embodiments.

In various embodiments, if it is determined in step 706 that the absolute value of the work zone difference is greater than or equal to the predetermined threshold, then the work zone is deemed to be not relevant (step 707), and the process returns to step 702 in a new iteration.

Conversely, in various embodiments, if it is instead determined in step 706 that the absolute value of the work zone difference is less than the predetermined threshold, then the process converts all longitudinal and lateral coordinates into x, y offsets, respectively, with respect to the position and heading of the vehicle (step 708).

Also in various embodiments, the processor determines whether the vehicle 100 is driving toward the work zone (step 710). In various embodiments, this is determined based on whether an “x” offset for the start of the work zone (i.e., to the transition area 1206 and/or work zone activity area 1208 of FIG. 12 in an exemplary embodiment) is greater than zero and also less than a predetermined longitudinal distance threshold, and whether an absolute value for a “y” offset for the start of the work zone is less than a predetermine latitudinal distance threshold.

In various embodiments, if it is determined in step 710 that the vehicle 100 is driving toward the work zone, then the work zone is deemed to be relevant (step 712).

Conversely, in various embodiments, if it is instead determined in step 710 that the vehicle 100 is not driving toward the work zone, then a determination is made as to whether the vehicle 100 is driving inside the work zone (step 714). In various embodiments, this is determined based on whether an “x” offset for the start of the work zone (i.e., to the transition area 1206 and/or work zone activity area 1208 of FIG. 12 in an exemplary embodiment) is less than zero, whether an “x” offset for the end of the work zone (i.e., for the termination area 1210 and/or work zone ending area 1212 in an exemplary embodiment) is greater than zero, and whether an absolute value for a “y” offset for the end of the work zone is less than a predetermine latitudinal distance threshold.

In various embodiments, if it is determined in step 714 that the vehicle 100 is driving within the work zone, then the work zone is deemed to be relevant (step 712).

Conversely, in various embodiments, if it is instead determined in step 714 that the vehicle 100 is not driving within the work zone, then the work zone is determined to be irrelevant (step 712).

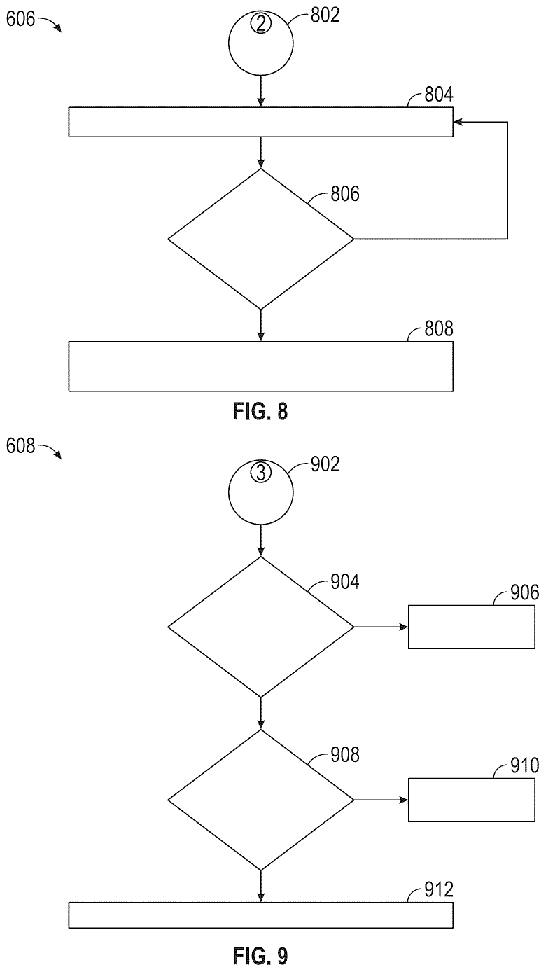

With reference now to FIG. 8, an exemplary implementation is provided for step 606 of FIG. 6 (as part of step 248 of FIG. 2), namely obtaining worker location feeds.

As depicted in FIG. 8, in an exemplary embodiment, the process begins at step 802, after which the processor finds and iterates all the worker location data from the work zone feed using a unique work zone identification (step 804).

Also in various embodiments, the processor determines whether the work zone feed and the workers location feed have the same work zone identification (ID) (step 806). In various embodiments, if the work zone feed and the workers location feed have the same ID, then the worker location feed is deemed to be relevant to the work zone, and is associated with the work zone feed (step 808). Otherwise, if the IDs do not match, then the workers location feed is discarded, and the process returns to step 804 as depicted in FIG. 8.

With reference now to FIG. 9, an exemplary implementation is provided for step 608 of FIG. 6 (as part of step 248 of FIG. 2), namely selected a reduced speed limit.

As depicted in FIG. 9, in an exemplary embodiment, the process begins at step 902, after which the processor determines whether the workers location feed is valid (step 904).

In various embodiments, if the workers location feed is determined in step 904 to be valid, then the speed limit is posted (step 906). In various embodiment, the speed limit is utilized as part of the display that is provided for the driver, including for the display of the speed limit itself and as part of the recommended vehicle maneuver (e.g., to slow down the vehicle 100).

Conversely, in various embodiments, if it is instead determined in step 904 that the workers location feed is not valid, then it is determined in step 908 whether the work zone feed is valid (step 908).

In various embodiments, if the work zone feed is determined in step 908 to be valid, then the speed limit is posted (step 910). In various embodiment, the speed limit is utilized as part of the display that is provided for the driver, including for the display of the speed limit itself and as part of the recommended vehicle maneuver (e.g., to slow down the vehicle 100).

Conversely, in various embodiments, if the work zone feed is instead determined in step 908 to be invalid, then the speed limit is set as “not available” (step 912). In various embodiment, an indication is presented that the speed limit is not available as part of the display that is provided for the driver, and is also therefor in certain embodiments not included as part of the recommended vehicle maneuver.

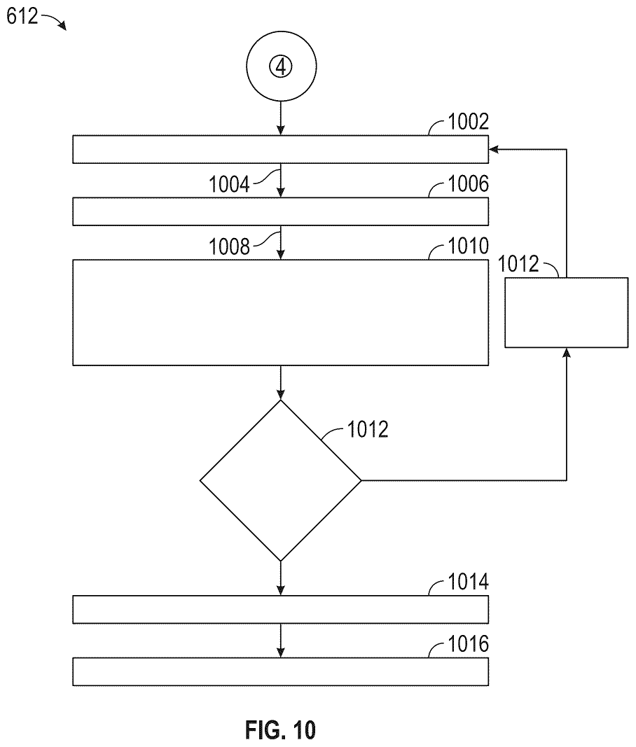

With reference now to FIG. 10, an exemplary implementation is provided for step 612 of FIG. 6 (as part of step 248 of FIG. 2), namely computing a lane of travel for the vehicle 100.

As depicted in FIG. 10, in an exemplary embodiment, the processor finds and iterates all the list of lanes in the work zone data (step 1002), resulting in a plurality of lanes 1004. Also in an exemplary embodiment, the processor also iterates, for each lane 1004, each of the waypoints of the lane (step 1006), resulting in a plurality of waypoints 1008 for each lane 1004.

Also in various embodiments, for each waypoint 1008 of each lane 1004, the processor converts its position coordinates from longitudinal and lateral coordinates to x, y offsets, respectfully, with respect to the position, and selects the waypoint 1008 with the shortest distance to the vehicle 100 (i.e., with a closest longitudinal point and a closes latitudinal point) (step 1010).

In various embodiments, the processor determines whether an absolute value of the closest “y” offset (i.e., of the closest point of the waypoint 1008 to the vehicle 100) is less than a predetermined value (step 1012). In certain embodiments, the predetermined value is equal to the width of the lane 1004. Alternatively, in certain embodiments, the predetermined value is set equal to some other similar value, such as three and one half meters in certain embodiments; although this may vary in other embodiments.

In various embodiments, if the absolute value of the closest “y” offset is less than the predetermined value, then the waypoint is matched to the lane (step 1014) and, the lane is set as the lane of travel of the vehicle 100 (step 1016). In various embodiments, these are performed via a processor, such as the processor 142.

Conversely, in various embodiments, if the absolute value of the closest “y” offset is greater than or equal to the predetermined value, then the waypoint is not matched to the lane (step 1018), and the process returns to step 1002 as depicted in FIG. 10.

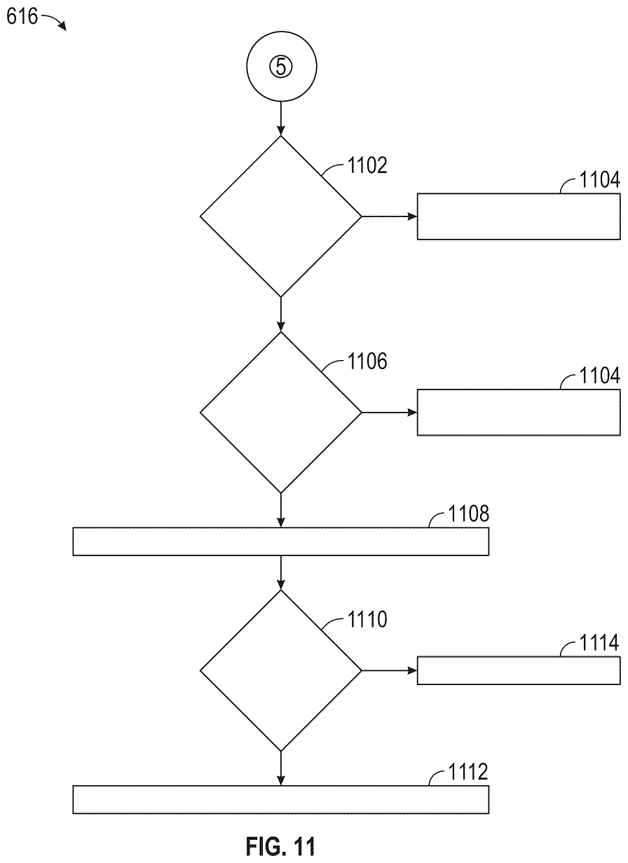

With reference now to FIG. 11, an exemplary implementation is provided for step 616 of FIG. 6 (as part of step 248 of FIG. 2), namely determining a suggested maneuver for the driver of the vehicle 100.

As depicted in FIG. 11, in an exemplary embodiment, the processor determines whether the lane matching was successful (step 1102). In an exemplary embodiment, the processor determines whether the lane matching of step 612 of FIG. 10 was successful in matching the lane (i.e., when the lane is matched in step 1014 and set as the lane of travel in step 1016 based on the determination of step 1012 of FIG. 6).

In various embodiments, if it is determined in step 1102 that the lane matching was not successful (i.e., that no matching was successfully performed in step 612), then no suggested maneuver is made for the driver and the vehicle 100 (step 1104).

Conversely, if it is instead determined in step 1102 that the lane matching was successful, then a determination is made as to whether the vehicle lane is closed (step 1106). Specifically, in various embodiments, the processor determines in step 1106 whether the current lane of travel of the vehicle 100 will be closed ahead due to the work zone (e.g., a construction zone for the roadway in which the vehicle 100 is travelling).

In various embodiments, if it is determined in step 1106 that the vehicle lane is not closed (i.e., when it is determined that the vehicle lane is open), then no suggested maneuver is made (step 1104).

Conversely, in various embodiments, if it is instead determined in step 1106 that the vehicle lane is closed, then an iteration is performed for the various possible lanes (step 1108). Specifically, in an exemplary embodiment, the processor iterates through all of the lanes of the work zone from the work zone feed. In certain embodiments, the iteration is performed from left to right, as the work zone lanes are ordered from left to right in the work zone data in an exemplary embodiment.

In various embodiments, a determination as to whether any lanes are open to the left of the vehicle (step 1110). In various embodiments, during step 1110, the processor determines whether any lanes to the left of the current lane of travel of the vehicle 100 are open (i.e., not closed or blocked) ahead during the work zone.

In various embodiments, if it is determined in step 1110 that one or more lanes are open to the left of the vehicle 100, then the processor determines that the suggested maneuver is to merge the vehicle 100 to the left (step 1112), and appropriate instructions are provided accordingly to the driver via the display system 135. Conversely, in various embodiments, if it is instead determined in step 1110 that no lanes are open to the left of the vehicle 100, then the processor determines that the suggested maneuver is instead to merge the vehicle 100 to the right (step 1114), and appropriate instructions are provided accordingly to the driver via the display system 135.

Accordingly, methods, systems, and vehicles are provided for facilitating a vehicle's travel through a work zone on a roadway in which the vehicle 100 is travelling. In various embodiments, as depicted in the Figures and described above, work zone data (including as to work zones and workers present) are obtained via one or more remote data sources 108 and are utilized by a remote server 170 in combination with the control system 102 (including a processor 142 thereof) in providing display information and recommended maneuvers for the vehicle 100 (e.g., including lane changes, merging, and/or speed reductions) using the work zone data, including lane-level map data, speed limit changes, workers present information, vehicle sensor data and location, and in certain embodiments other data relating thereto. In addition, in certain embodiments, the processor 142 may automatically move the vehicle 100 to implement the suggested maneuvers (e.g., changing lanes, merging, and reducing vehicle speed as appropriate) via instructions that are provided by the processor 142 and that are implemented via the drive system 110 of FIG. 1 (and/or in certain embodiments via a steering system, braking system, and/or one or more other systems that may be part of the drive system 110 and/or coupled thereto and/or to the control system 102 in various embodiments).

It will be appreciated that the systems, vehicles, and methods may vary from those depicted in the Figures and described herein. For example, the system 10, including the remote server 170, the data source 180, the vehicle 100 of FIG. 1 and the control system 102 thereof, and/or other components thereof may differ from that depicted in FIG. 1. It will similarly be appreciated that the steps of the processes and implementations of FIGS. 2-13B may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining, via one or more remote sources that are remote to a vehicle, work zone data pertaining to a work zone of a roadway in proximity to the vehicle as the vehicle is travelling;
obtaining, one or more sensors and location systems of the vehicle, location information as to the vehicle;
determining, via one or more processors, display information pertaining to the work zone, based on the work zone data and the location information; and
outputting the display information on a display system of the vehicle to a driver, to an automated vehicle system, or both, in accordance with instructions provided by the one or more processors.

2. The method of claim 1, wherein:
the location information includes a position and heading of the vehicle as determined via a satellite-based location system of the vehicle in addition to a speed of the vehicle as determined via one or more speed sensors of the vehicle; and
the determining of the display information is based on the position, heading, and speed of the vehicle in addition to the work zone data.

3. The method of claim 1, further comprising:
determining, via the one or more processors, one or more recommended maneuvers for the vehicle based on the work zone data and the location information; and
outputting the one or more recommended maneuvers as part of the display information on the display system of the vehicle, in accordance with instructions provided by the one or more processors.

4. The method of claim 3, wherein the one or more recommended maneuvers comprise a lane merge based on one or more lane closures based on the work zone data and the location information.

5. The method of claim 3, wherein the one or more recommended maneuvers comprise a reduction in speed of the vehicle based on one or more changes reductions in a speed limit of the roadway based on the work zone data and the location information.

6. The method of claim 1, further comprising:
obtaining, via a remote server that is remote from the vehicle, lane-level map data pertaining to the roadway; and
combining, via the one or more processors, the work zone data with the lane-level map data, generated unified work zone data;
wherein the display information is determined via the one or more processors based on the unified work zone data.

7. The method of claim 6, wherein:
the work zone data includes lane-specific work zone data as to any lane closures in one or more specific lanes of the roadway in addition to any speed limit reductions of the roadway as well as whether any workers are present; and
the combining includes combining of the lane-specific work zone data with the lane-level map data, including any lane closures, any speed limit reductions, and whether any workers are present, in generating the unified work zone data.

8. The method of claim 1, wherein the determining and outputting of the display information is further based on a ranking of relevance of a plurality of work zones based on respective relative distances of each of the plurality of work zones to the vehicle in addition to respective impacts of relative impacts of each of the plurality of work zones on one or more vehicle maneuvers required for the vehicle, including one or more lane merge maneuvers, one or more speed reductions for the vehicle, or both.

9. The method of claim 1, further comprising:
automatically controlling one or more vehicle control actions for the vehicle, via a drive system of the vehicle that is part of the automated vehicle system, in accordance with instructions provided by the one or more processors, based on the work zone data and the location information.

10. A system comprising:
a transceiver that is configured to at least facilitate obtaining, via one or more remote sources that are remote to a vehicle, work zone data pertaining to a work zone of a roadway in proximity to the vehicle as the vehicle is travelling;
one or more sensors and location systems of the vehicle that are configured to at least facilitate obtaining location information as to the vehicle; and
one or more processors that are configured to at least facilitate:
determining display information pertaining to the work zone, based on the work zone data and the location information; and
outputting the display information on a display system of the vehicle to a driver, to an automated vehicle system, or both, in accordance with instructions provided by the one or more processors.

11. The system of claim 10, wherein:
the location information includes a position and heading of the vehicle as determined via a satellite-based location system of the vehicle in addition to a speed of the vehicle as determined via one or more speed sensors of the vehicle; and
the one or more processors are configured to at least facilitate determining the display information is based on the position, heading, and speed of the vehicle in addition to the work zone data.

12. The system of claim 10, wherein the one or more processors are configured to at least facilitate:
determining one or more recommended maneuvers for the vehicle based on the work zone data and the location information; and
outputting the one or more recommended maneuvers as part of the display information on the display system of the vehicle, in accordance with instructions provided by the one or more processors.

13. The system of claim 12, wherein the one or more recommended maneuvers comprise a lane merge based on one or more lane closures based on the work zone data and the location information.

14. The system of claim 12, wherein the one or more recommended maneuvers comprise a reduction in speed of the vehicle based on one or more changes reductions in a speed limit of the roadway based on the work zone data and the location information.

15. The system of claim 10, wherein the one or more processors are configured to at least facilitate:
obtaining, via a remote server that is remote from the vehicle, lane-level map data pertaining to the roadway;
combining the work zone data with the lane-level map data, generated unified work zone data; and
determining the display information based on the unified work zone data.

16. The system of claim 15, wherein:
the work zone data includes lane-specific work zone data as to any lane closures in one or more specific lanes of the roadway in addition to any speed limit reductions of the roadway as well as whether any workers are present; and
the one or more processors are configured to at least facilitate combining the lane-specific work zone data with the lane-level map data, including any lane closures, any speed limit reductions, and whether any workers are present, in generating the unified work zone data.

17. The system of claim 10, wherein the one or more processors are further configured to at least facilitate determining and outputting of the display information further based on a ranking of relevance of a plurality of work zones based on respective relative distances of each of the plurality of work zones to the vehicle in addition to respective impacts of relative impacts of each of the plurality of work zones on one or more vehicle maneuvers required for the vehicle, including one or more lane merge maneuvers, one or more speed reductions for the vehicle, or both.

18. The system of claim 10, wherein the one or more processors are further configured to at least facilitate automatically controlling one or more vehicle control actions for the vehicle, via a drive system of the vehicle that is part of the automated vehicle system, in accordance with instructions provided by the one or more processors, based on the work zone data and the location information.

19. A communications system comprising:
a vehicle having one or more sensors, a location system, and a display system; and
a remote server that is remote from the vehicle and also remote from one or more other data sources that provide lane-specific work zone data as to a work zone along a roadway in which the vehicle is to be travelling, including as to whether any workers are present in the work zone, and further including any closed lanes of the roadway and any speed limit changes of the roadway based on the work zone, the remote server configured to at least facilitate:
obtaining the lane-specific work zone data from the one or more other data sources;
obtaining lane-level map data pertaining to the roadway on which the work zone is located; and
obtaining location information from the vehicle that includes a heading, position, and speed of the vehicle as determined via the one or sensors and the location system of the vehicle;
wherein the vehicle, the remote server, or both have one or more processors that are configured to at least facilitate:
combining the lane-specific work zone data with the lane-level map data, generated unified work zone data with respect to the work zone and the vehicle;
determining display information pertaining to the work zone, including one or more recommended maneuvers for the vehicle based on the lane-specific work zone data and the location information, the one or more recommended maneuvers including one or more lane merge maneuvers, one or more speed reductions, or both, based on the work zone; and
outputting the display information on the display system of the vehicle to a driver, to an automated vehicle system, or both, including the one or more recommended maneuvers for the vehicle, in accordance with instructions provided by the one or more processors.

20. The communications system of claim 19, wherein the one or more processors are configured to at least facilitate determining and outputting of the display information further based on a ranking of relevance of a plurality of work zones based on respective relative distances of each of the plurality of work zones to the vehicle in addition to respective impacts of relative impacts of each of the plurality of work zones on one or more vehicle maneuvers required for the vehicle, including the one or more lane merge maneuvers, the one or more speed reductions for the vehicle, or both.
